(19) United States
(12) Patent Application Publication
(10) Pub. No.: US 2007/0076876 A1
(43) Pub. Date: Apr. 5, 2007

(54) System for the compression, encoding, authoring, and encryption of data and media the storage of such content in external mobile telephone or personal digital assistant compatible memory devices

(76) Inventor: Mark M. Kaplan, New York, NY (US)

Correspondence Address: David A. Kalow, Esq.;Kalow & Springut LLP, 19th Floor, 488 Madison Avenue, New York, NY, 10022, US

(21) Appl. No.: 10/519,909

(22) PCT Filed: Nov. 4, 2004
(86) PCT No.: PCT/US04/36725

§ 371 Date: Apr. 13, 2006

Related U.S. Application Data
(60) Provisional application No. 60/612,536, filed on Sep. 24, 2004.

(51) Int. Cl. H04K 1/00

(52) U.S. Cl. 380/255; 455/410

(57) ABSTRACT

A unique combination of compression, encoding, authoring, and encryption software practices to store large data and media files onto external mobile handset and PDA compatible memory devices. The unique combination allows for a copy protected handset and PDA compatible external memory device with pre-installed data and media. A multimedia player is also written in the external memory device along with the processed data and/or media files, wherein the multimedia player is used to render the stored data and/or media files in a mobile device such as an external mobile handset or PDA. The memory device is inserted into a mobile handset or PDA for access by a user.

### RELATED APPLICATIONS

The present application claims the benefit of provisional patent application entitled “A System and Method for Compressing, Encoding, Authoring, and Encrypting Data Content and Media, and the Application of Such Content to External Mobile Telephone Compatible or Personal Digital Assistant Compatible Memory Devices”, Ser. No. 60/612,536, filed Sep. 24, 2004, now pending, which is hereby incorporated by reference.

### BACKGROUND OF THE INVENTION

1. Field of Invention

The present invention relates to the compression, encoding, authoring, and encryption of data and audio/video content for application in external memory devices and, more specifically, in external memory devices compatible for use with mobile handsets, such as mobile telephones (handsets) and Personal Digital Assistants (PDAs).

2. Discussion of Prior Art

Currently blank third-party memory devices, such as flash drives, are manufactured for personal storage of media and data that are either too large to remotely access or too large to store directly on a handset or PDA. Current external memory devices have capacities of 32 megabyte (MB), 64 MB, 128 MB, 512 MB and 1 gigabyte. These memory limitations are restrictive to the application of high volume files like, high quality video and large data/video embedded files among others.

Such memory devices are manufactured to be rewritable, so that a consumer may add or replace media from their handset or other compatible device. Additionally, as the memory device is not copy-protected, media may also be transferred between data receivers such as computers, handsets, PDAs, etc. Such transfer may be accomplished via a multitude of mechanisms including Bluetooth, Wireless Access Protocol (WAP), General Packet Radio Service (GPRS), Internet, a cable connection (e.g., USB cable, Firewire cable, serial cable, etc), or internally within any compatible piece of hardware. The ability to transmit data and media contained within handsets makes it hard to ensure protection of copyrights.

FIG. 1 illustrates two common means (direct and indirect) via which data (e.g., multimedia data) 102 is transferred from a remote location (e.g., server 101) to a mobile device, such as mobile phone 104 or PDA 106. In the direct delivery scenario, the mobile device utilizes a pointer (such as an URL) and gains access to streaming data and/or media file(s), wherein the necessary data/media file(s) is directly downloaded onto the mobile device 104 or 106. Such a transfer is usually done over the wireless Web or using other transmission schemes that are compatible with the mobile device (e.g., WAP or GPRS).

In the indirect deliver scenario, the data/media file(s) is first transferred from the remote location (e.g., server 101) to an intermediate computer (such as a computer located at a home or office) 108. Such a transfer is usually done over a network such as the Internet. Next, the data/media file(s) is transferred from the intermediate computer 108 to the mobile handsets 104 or PDA 106. The transfer of data from the intermediate computer 108 to the mobile device 104 or 106 is usually done either wirelessly (e.g., Bluetooth) or via a connection such as a USB cable. A problem with both scenarios described in FIG. 1 is that the data transfer process does not ensure protection of copyrights.

In addition to the copyright protection disadvantage of prior art, there are numerous consumer disadvantages. For example, there is no teaching in the prior art for simplifying the multimedia experience in a portable memory device using a user menu and branded front page or “splash page” from which the consumer may choose to view all of the media in a particular order, or any other combination or sequence they desire. Furthermore, the prior art also fails to provide for a memory device that comes with a pre-loaded media player, such that if the memory device is purchased, the user is guaranteed access the media using the pre-loaded player.

Whatever the precise merits, features, and advantages of the above mentioned prior art, none of them achieves or fulfills the purposes of the present invention.

### SUMMARY OF THE INVENTION

The present invention provides for a method to store data and multimedia files onto external memory devices for use with mobile devices (e.g., PDAs or handhelds), wherein the method comprising the steps of: (a) receiving multimedia data such as video, audio, multimedia data (wherein such data can be received over a network such as the Internet or extracted from an optical disk such as a DVD); (b) encoding and compressing the received multimedia data in a format compatible with at least one mobile device; (c) authoring a multimedia asset with a menu based on the encoded and compressed multimedia data; (d) transferring a media player and the authored multimedia asset onto at least one external memory device; and (e) encrypting the transferred multimedia asset in the external memory device(s). The stored multimedia asset is accessible when the external memory device (with the encrypted multimedia asset) is used in conjunction with a compatible mobile device (such as being inserted in a compatible device). For example, the Treo 600™ memory device uses the SanDisc™ brand external memory device. The unique result is the recreation of a consumer experience that is commonly found only on optical video discs such as DVDs.

The present invention also provides for a method to apply data and multimedia files onto external memory devices for use with mobile devices(e.g., PDAs or handhelds), wherein the method comprises the steps of: (a) extracting multimedia content and menu data from an optical disk (e.g., DVD disk); (b) encoding the menu data in a format compatible with at least one mobile device; (c) encoding and compressing the extracted multimedia data in a format compatible with at least one mobile device; (d) authoring a multimedia asset with the encoded menu data based on the encoded and compressed multimedia data; (e) transferring the authored multimedia asset onto at least one external memory device along with a multimedia player to playback the authored multimedia asset; and (f) encrypting the transferred multimedia asset in the external memory device(s). The multimedia asset is accessible when the external memory device with the encrypted multimedia asset is used in conjunction with a compatible mobile device (such as being inserted in a memory slot of a portable phone or PDA).

The present invention also provides for an external memory device for use with at least one mobile device, wherein the external memory device comprises a storage area storing menu data, storage area storing audio data, storage area storing video data, and storage area storing an embedded multimedia player to playback in a compatible mobile device the audio and video data, wherein the menu, audio, and video data are created and written onto the external memory device based on encoding, compressing, authoring, and encrypting corresponding data stored in an optical disk.

### BRIEF DESCRIPTION OF THE DRAWINGS

FIG. 1 illustrates two common means (direct and indirect) via which data (e.g., multimedia data) is transferred from a remote location (e.g., a server) to a mobile device, such as a mobile phone or a PDA.

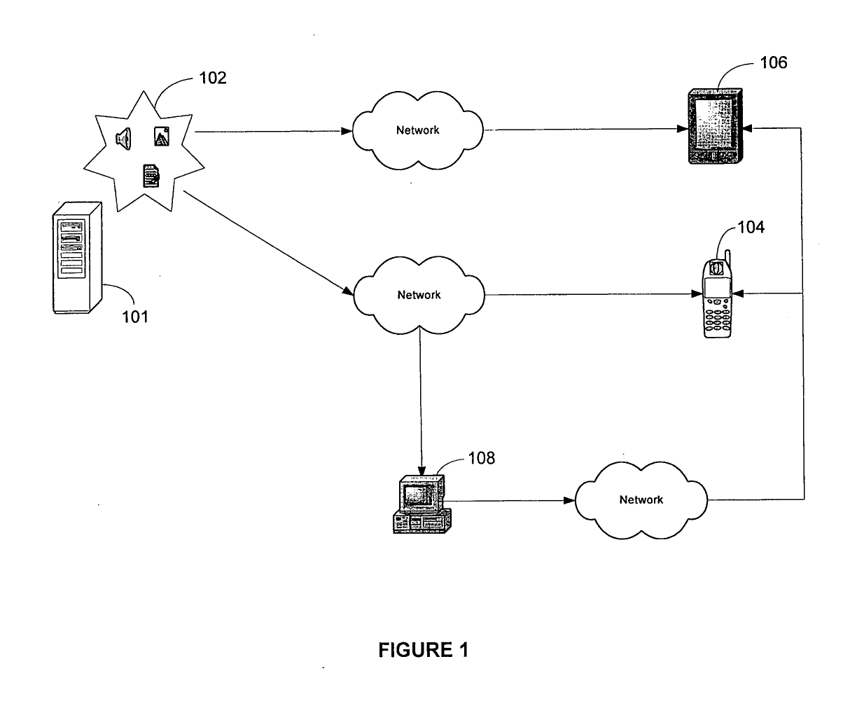

FIG. 2 illustrates a general overview of the unique combination as taught by the present invention.

FIG. 3 illustrates an exemplary method associated with the present invention.

FIG. 4 illustrates the present invention's method for re-encoding multimedia data along with menus.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

The present invention provides for a system and method that utilize a unique combination of compression, encoding, authoring, and encryption software and practices to store large data and media files onto external mobile handset and PDA compatible memory devices. The resulting handset and PDA compatible external memory device is a copy protected device with pre-installed data and media. A user is able to access the content by inserting the copy protected memory device into a handset or PDA.

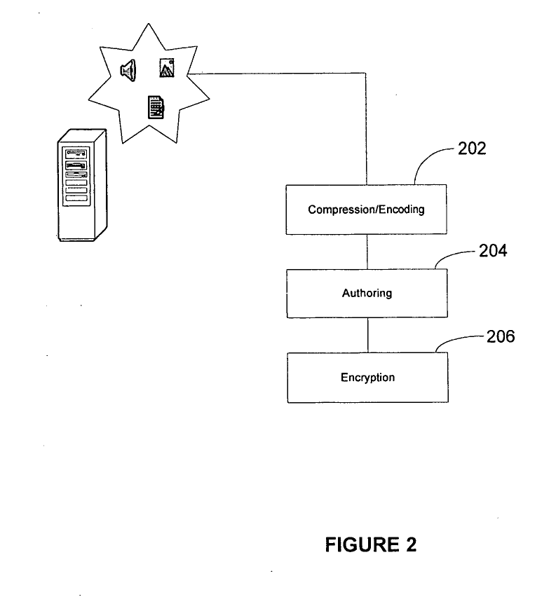

FIG. 2 illustrates a general overview of the unique combination as taught by the present invention. In step 202, the data and/or media file(s) is compressed and encoded in a format compatible with the destination mobile device. It should be noted that in the preferred embodiment, encoding is done in synchronicity with compression. Furthermore, in one example, the media/video assets are encoded/compressed two-ways as generic 3GPP content or as Kinoma files for compatibility with Palm devices. In step 204, the compressed/encoded data is authored via a multimedia software tool, and in step 208, the authored data is encrypted and is made ready for storage in a portable memory device. In the preferred embodiment, authoring is done via a standard authoring application with the output being exported in an interactive 3GPP format or Kinoma format. In one specific example, the authored data comprises the multimedia data, a selection menu, and an embedded media player to render the multimedia data. In the preferred embodiment, encryption is handled by the built-in digital rights management of MPEG4 or 3GPP content. In another embodiment, the memory is set in a read only format.

In the current invention, applications such as (but not limited to) Apple's Final Cut Pro®, Final Cut Express®, QuickTime Pro®, iMovie®, Adobe GoLive®, Discreet Cleaner® and other applications that use architecture such as the QuickTime® architecture are used to encode, author, and compress the data and media (which includes any combination of audio, video, and text data) into files such as 3GPP and 3GPP2 compatible files. The files are then transferred from the computer to an external port where the memory device is written uniquely encrypted for copy protection.

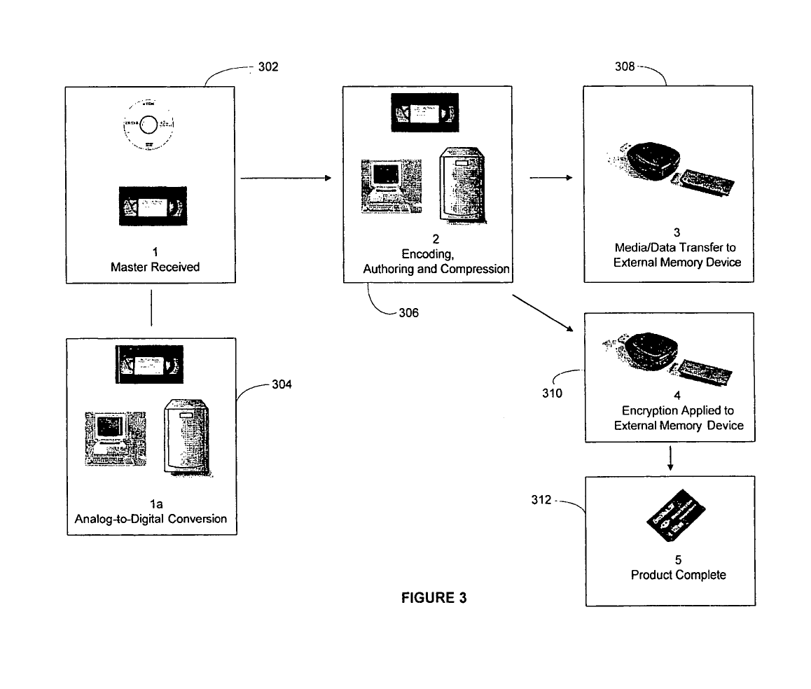

FIG. 3 illustrates an exemplary method associated with the present invention. As shown in step 302, a master copy of the original media or data asset is provided as a digital file. The digital file can be sent as a hard copy on computer storage medium that includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory, writable memory device, or data storage devices. Alternatively, the digital file can be received from a remote location over a network such as the Internet.

It should be noted that audio/video assets can also be provided on a VHS or Cassette tape. As shown in step 304, if the master file is provided on a VHS or Cassette tape, the asset is reformatted into a digital file via an analog-to-digital conversion process.

In step 306, the original asset is encoded, authored, and compressed into a format such as (but not limited to) 3GPP and 3GPP2 format, using a program such as (but not limited to) a QuickTime® based program.

In step 308, the file is then transferred from the CPU/server to the external port housing the blank memory device where the media or data is applied.

Following application of the data or media to the memory device, in 310, encryption is applied and, in 312, the copy protected device is ready to be used with a portable device (such as a mobile handset or PDA). It should be noted that once encryption is applied to the external memory device, it is copy protected and cannot be altered.

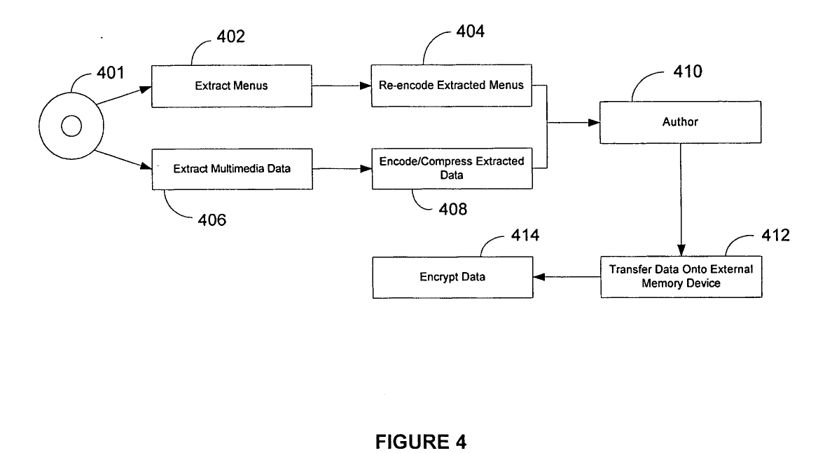

FIG. 4 illustrates the present invention's method for re-encoding multimedia data along with menus. In this embodiment, the copy protected memory device stores an encrypted version of a movie along with menus such as menus commonly found on DVDs. In step 402, the menus are extracted along with the links from the source disk (e.g., source DVD disk) 401 and, in step 404, the extracted menu is re-encoded along with the links. In step 406, multimedia data (e.g., video and audio data) is extracted from the source disk 408, and the extracted multimedia data is encoded/compressed in a format compatible with the destination mobile device (e.g., PDA or handset). In step 410, the newly encoded menu with links and corresponding encoded/compressed multimedia data is authored using a multimedia authoring tool, and in step 412 are written to the copy protected memory device. In the preferred embodiment, the authored multimedia asset, the newly encoded menu, and an embedded media player (for rendering the multimedia data) are transferred onto the external memory device. Next, in step 414, the transferred data is encrypted using an encryption algorithm.

In this embodiment, the user of a portable device with such a copy protected memory device experiences the same visual effects (e.g., menus, etc.) as a user experiencing the playback of a DVD disk in a stand alone player. In one embodiment, branded logos, animated and non-animated, are used prior to the menu being displayed to the user. In an extended embodiment, an information screen is shown when a logo is clicked by the user. In another embodiment, the menu page has a play link, an instruction menu, and content of disc. In the preferred embodiment, the animation graphics are prepared in Macromedia Flash™ format for deployment as 3GPPP content.

Additionally, the present invention provides for an article of manufacture comprising computer readable program code contained within implementing one or more modules to compress, encode, author, and encrypt data and media file(s) for storage in external mobile telephone or PDA compatible memory devices. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules for: (a) aiding in the extraction of multimedia data from an source such as a DVD disk; (b) encoding and compressing multimedia data (such as data from the DVD) in a format compatible with at least one mobile device; (c) authoring a multimedia asset with a menu based on said encoded and compressed multimedia data; (d) aiding in the transfer of a media player and said authored multimedia asset with said menu onto at least one external memory device, wherein the media player chosen to ensure playback of the multimedia asset with the menu; and (e) encrypting the transferred multimedia asset in the external memory device(s), wherein the multimedia asset is accessible when said external memory device, with the encrypted multimedia asset, is used in conjunction with a compatible mobile device.

Also implemented in computer program code based products are software modules for: (a) extracting multimedia content and menu data from a storage medium (such as an optical disk); (b) encoding the menu data in a format compatible with at least one mobile device; (c) encoding and compressing the received multimedia data in a format compatible with at least one mobile device; (d) authoring a multimedia asset based on the encoded menu data and the encoded and compressed multimedia data; (e) aiding in the transfer of the authored multimedia asset onto an external memory device along with a multimedia player to playback the authored multimedia asset; and (f) encrypting said transferred multimedia asset in said external memory device, wherein the multimedia asset is accessible when the external memory device with the encrypted multimedia asset is used in conjunction with a compatible mobile device.

### CONCLUSION

A system and method has been shown in the above embodiments for the effective implementation of a system and method for the compression, encoding, authoring, and encryption of data and media file(s), and the application of such content in external memory devices associated with module devices (e.g., mobile phones, PDAs). While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by type of memory device, type of compression scheme used, type of encoding scheme used, type of multimedia authoring tool used, type of multimedia playback player used, type of mobile device, type of data encryption used, file formats, specific software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of digital rights management, compression schemes, encoding schemes, encryption schemes, and multimedia editing.

1. A method to store data and multimedia files onto external memory devices for use with mobile devices, said method comprising the steps of:
(a) receiving multimedia data;
(b) encoding and compressing said received multimedia data in a format compatible with at least one mobile device;
(c) authoring a multimedia asset with a menu based on said encoded and compressed multimedia data;
(d) transferring a media player and said authored multimedia asset with said menu onto at least one external memory device, said media player chosen to ensure playback of multimedia asset with said menu;
(e) encrypting said transferred multimedia asset in said at least one external memory device, and
wherein said multimedia asset is accessible when said at least one external memory device, with said encrypted multimedia asset, is used in conjunction with a compatible mobile device.

2. A method to store data and multimedia files onto external memory devices for use with mobile devices, as per claim 1, wherein said multimedia data in step (a) is received over a network.

3. A method to store data and multimedia files onto external memory devices for use with mobile devices, as per claim 2, wherein said network is any of the following: local area network (LAN), wide area network (WAN), wireless network, cellular network, or the Internet.

4. A method to store data and multimedia files onto external memory devices for use with mobile devices, as per claim 1, wherein said multimedia data in step (a) corresponds to data extracted from an optical disk.

5. A method to store data and multimedia files onto external memory devices for use with mobile devices, as per claim 4, wherein said optical disk is a DVD.

6. A method to store data and multimedia files onto external memory devices for use with mobile devices, as per claim 1, wherein said multimedia data comprises video data, audio data, and menu data.

7. A method to store data and multimedia files onto external memory devices for use with mobile devices, as per claim 1, wherein said multimedia data is data associated with a multimedia score card.

8. A method to store data and multimedia files onto external memory devices for use with mobile devices, as per claim 1, wherein said multimedia data is data associated with a video game.

9. A method to store data and multimedia files onto external memory devices for use with mobile devices, as per claim 1, wherein when said multimedia is stored in an analog format, said method further comprises the step of performing a analog-to-digital conversion prior to said encoding and compression step (b).

10. A method to store data and multimedia files onto external memory devices for use with mobile devices, as per claim 1, wherein said mobile device is any of the following: a personal digital assistant (PDA) or a mobile handset.

11. An external memory device for use with at least one mobile device, said external memory device comprising:
storage region storing audio data;
storage region storing video data;
storage region fstoring menu data;
storage region storing an embedded media player to playback in a compatible mobile device said audio and video data, and
wherein said menu, audio, and video data are created and written onto said external memory device based on encoding, compressing, authoring, and encrypting corresponding data stored in an optical disk.

12. An external memory device as per claim 11, wherein said optical disk is a DVD containing a movie, a television show, or a long or short form of video.

13. An external memory device as per claim 11, wherein said mobile device is any of the following: a personal digital assistant (PDA) or a mobile handset.

14. A method to store data and multimedia files onto external memory devices for use with mobile devices, said method comprising the steps of:
(a) extracting multimedia content and menu data from a storage medium;
(b) encoding said menu data in a format compatible with at least one mobile device;
(c) encoding and compressing said received multimedia data in said format compatible with at least one mobile device;
(d) authoring a multimedia asset based on said encoded menu data and said encoded and compressed multimedia data;
(e) transferring said authored multimedia asset onto at least one external memory device with a multimedia player to playback said authored multimedia asset;
(f) encrypting said transferred multimedia asset in said at least one external memory device, and
wherein said multimedia asset is accessible when said at least one external memory device with said encrypted multimedia asset is used in conjunction with a compatible mobile device.

15. A method to store data and multimedia files onto external memory devices for use with mobile devices, as per claim 14, wherein said storage medium is an optical disk.

16. A method to store data and multimedia files onto external memory devices for use with mobile devices, as per claim 15, wherein said optical disk is a DVD.

17. A method to store data and multimedia files onto external memory devices for use with mobile devices, as per claim 14, wherein said multimedia content and menu data are associated with a movie, a television show, or a long or short form of video.

18. A method to store data and multimedia files onto external memory devices for use with mobile devices, as per claim 14, wherein said mobile device is any of the following: a personal digital assistant (PDA) or a mobile handset.

19. An article of manufacture comprising a computer user medium having computer readable program code embodied therein which implements a method to store data and multimedia files onto external memory devices for use with mobile devices, said medium comprising:
(a) computer readable program code extracting multimedia data;
(b) computer readable program code encoding and compressing said received multimedia data in a format compatible with at least one mobile device;
(c) computer readable program code authoring a multimedia asset with a menu based on said encoded and compressed multimedia data;
(d) computer readable program code aiding in the transfer of a media player and said authored multimedia asset with said menu onto at least one external memory device, said media player chosen to ensure playback of multimedia asset with said menu;
(e) computer readable program code encrypting said transferred multimedia asset in said at least one external memory device, and
wherein said multimedia asset is accessible when said at least one external memory device, with said encrypted multimedia asset, is used in conjunction with a compatible mobile device.

20. An article of manufacture comprising a computer user medium having computer readable program code embodied therein which implements a method to store data and multimedia files onto external memory devices for use with mobile devices, said method comprising the steps of:
(a) computer readable program code aiding in the extraction of multimedia content and menu data from an optical disk;
(b) computer readable program code encoding said menu data in a format compatible with at least one mobile device;
(c) computer readable program code encoding and compressing said received multimedia data in said format compatible with at least one mobile device;
(d) computer readable program code authoring a multimedia asset based on said encoded menu data and said encoded and compressed multimedia data;
(e) computer readable program code aiding in the transfer of said authored multimedia asset onto at least one external memory device with a multimedia player to playback said authored multimedia asset;
(f) computer readable program code encrypting said transferred multimedia asset in said at least one external memory device, and
wherein said multimedia asset is accessible when said at least one external memory device, with said encrypted multimedia asset, is used in conjunction with a compatible mobile device.
